(19) United States
(12) Patent Application Publication
(10) Pub. No.: US 2025/0021105 A1
(43) Pub. Date: Jan. 16, 2025

(54) SYSTEM OPTIMIZATION FOR AUTONOMOUS TERMINAL TRACTOR OPERATION

(71) Applicant: Cummins Inc., Columbus, IN (US)

(72) Inventors: Ninad Ghike, Columbus, IN (US); Paul V. Moonjelly, Columbus, IN (US); Jeffrey David Selwyn Diwakar Abraham, Columbus, IN (US)

(73) Assignee: Cummins Inc., Columbus, IN (US)

(21) Appl. No.: 18/902,809

(22) Filed: Sep. 30, 2024

Related U.S. Application Data
(63) Continuation of application No. PCT/US2023/017112, filed on Mar. 31, 2023.
(60) Provisional application No. 63/326,547, filed on Apr. 1, 2022.

(51) Int. Cl. G05D 1/225; B60W 10/06; B60W 10/08; B60W 10/18; B60W 10/20; B60W 30/08; B60W 60/00; G01C 21/00

(52) U.S. Cl. CPC G05D 1/225; B60W 10/06; B60W 10/08; B60W 10/18; B60W 10/20; B60W 30/08; B60W 60/00256; G01C 21/3841; B60W 2554/404; B60W 2554/802; B60W 2556/40; B60W 2556/45; B60W 2710/0627; B60W 2710/086; B60W 2710/18; B60W 2710/20; B60W 2720/10; B60W 2720/24

(57) ABSTRACT

Systems and methods for autonomous vehicle control are provided. A remote computing system includes a communication interface coupled to a network, a map database storing centralized map data, a processor, and a memory storing instructions that, when executed by the processor, cause the processor to perform operations. The operations include: receiving a transport request including a first location and a second location; selecting a first vehicle of a plurality of vehicles for the transport request based on at least one of the transport request and a vehicle status; transmitting the centralized map data to the first vehicle; causing the first vehicle to complete the transport request, including causing the first vehicle to autonomously transport from the first location to the second location and causing the first vehicle to collect first sensor data; receiving the first sensor data in real-time; and, updating the centralized map data with the first sensor data.

### CROSS-REFERENCE TO RELATED APPLICATIONS

This application is a continuation of International Application No. PCT/US2023/017112, filed Mar. 31, 2023, which claims the benefit of and priority to U.S. Provisional Patent Application No. 63/326,547, filed Apr. 1, 2022, both of which are incorporated herein by reference in their entireties and for all purposes.

### TECHNICAL FIELD

The present disclosure relates generally to the field of system optimization for autonomous vehicle operation and, more particularly, to autonomous terminal tractor operation.

### BACKGROUND

Autonomous or “self-driving” vehicles are becoming more prevalent. The autonomous vehicles may be powered by a variety of powertrains, such as an internal combustion engine, a hybrid powertrain containing an electric motor and an alternate power source (internal combustion engine, fuel cell, etc.), an electric powertrain (no internal combustion engine), a fuel cell powertrain, etc. The different powertrains may periodically require maintenance, refueling, and/or recharging. Maintenance, refueling, and/or recharging may interrupt a “duty cycle”, when the autonomous vehicle is performing working activities (e.g., hauling loads or freight, transportation, etc.). However, the amount, duration, location, and/or timing of the working activities may need to change to accommodate maintenance, refueling, and/or recharging. Improved systems and methods for autonomous vehicle operation are desired to optimize vehicle/fleet working activities.

### SUMMARY

One embodiment relates to a remote computing system including a communication interface structured to couple to a network, a map database storing centralized map data, one or more processors, and one or more memory devices storing instructions that, when executed by the one or more processors, cause the one or more processors to perform operations. The operations include: receiving a transport request, the transport request including a first location and a second location; selecting a first vehicle of a plurality of vehicles for the transport request, the first vehicle selected based on at least one of the transport request and a vehicle status for each of the plurality of vehicles; selectively transmitting the centralized map data to the first vehicle; causing the first vehicle to complete the transport request that includes causing the first vehicle to autonomously transport from the first location to the second location and causing the first vehicle to collect first sensor data while autonomously transporting from the first location to the second location; receiving the first sensor data in real-time; and, selectively updating the centralized map data with the first sensor data.

Another embodiment relates to a method. The method includes: receiving, by a computing system, a transport request, the transport request including a first location and a second location; selecting, by the computing system, a first vehicle of a plurality of vehicles for the transport request, the first vehicle selected based on at least one of the transport request and a vehicle status for each of the plurality of vehicles; selectively transmitting, by the computing system, centralized map data to the first vehicle; causing, by the computing system, the first vehicle to complete the transport request, where completing the transport request includes: causing the first vehicle to autonomously transport from the first location to the second location, and causing the first vehicle to collect first sensor data while autonomously transporting from the first location to the second location; receiving, by the computing system, the first sensor data in real-time; and selectively updating, by the computing system, the centralized map data with the first sensor data.

Yet another embodiment relates to a vehicle. The vehicle includes one or more sensors and a controller. The controller is configured to receive, from a remote computing system, map data; receive, from the remote computing system, transportation instructions, the transportation instructions including a first location and a second location; generate autonomous vehicle control signals, the autonomous vehicle control signals causing the vehicle to autonomously transport from the first location to the second location; receive, from the one or more sensors, sensor data while autonomously transporting from the first location to the second location; and selectively updating the received map data with the sensor data.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a computing system for optimizing autonomous vehicle operation, according to an example embodiment.

FIG. 2 is a block diagram of the vehicle of the system of FIG. 1, according to an example embodiment.

FIG. 3 is a flow diagram of a method for controlling the vehicle of FIG. 2, according to an example embodiment.

FIG. 4 is a flow diagram of a method for optimizing the vehicle of FIG. 2, according to an example embodiment.

FIG. 5 is a flow diagram of a method for optimizing the vehicle of FIG. 2, according to an example embodiment.

These and other features, together with the organization and manner of operation thereof, will become apparent from the following detailed description when taken in conjunction with the accompanying drawings

### DETAILED DESCRIPTION

Following below are more detailed descriptions of various concepts related to, and implementations of methods, apparatuses, and systems for optimizing autonomous vehicle operation. The various concepts introduced herein may be implemented in any number of ways, as the concepts described are not limited to any particular manner of implementation. Examples of specific implementations and applications are provided primarily for illustrative purposes

Referring to the Figures generally, the various embodiments disclosed herein relate to systems, apparatuses, and methods for optimizing autonomous vehicle operation. A controller (e.g., an engine control module (ECM), an engine control unit (ECU), and/or another electronic control unit) for a vehicle includes at least one processor and at least one memory storing instructions that, when executed by the processor, cause the controller to perform various operations. The operations include detecting one or more operational parameters of the vehicle, such as an engine fuel economy, an average engine load, duty cycle information, powertrain information (e.g., powertrain type, average engine temperatures, pressures, etc.), fueling/battery information (e.g., fuel amount, fuel type, fuel consumption rate, battery state of charge, battery charge consumption rate, etc.), emission information (e.g., engine exhaust emissions, exhaust aftertreatment system health, etc.), and/or other operational parameters. The operations may also include detecting map data by one or more computer vision sensors such a radar, a camera, and/or LIDAR, and/or positioning sensors such as a global positioning system (GPS) device, a global navigation satellite system (GNSS) device, a differential GNSS (DGNSS) device, and/or using one or more positioning techniques such as real-time kinematic (RTK). The one or more operational parameters and/or the map data may be transmitted to a remote (e.g., off-vehicle) computing system directly (e.g., via a network) or indirectly (e.g., via a user device). The remote computing system may receive a transportation request that includes a request to use a vehicle to transport a load. The remote computing system may analyze the one or more operational parameters and determine a vehicle for the transportation request.

Technically and beneficially, the systems, methods, and apparatuses described herein provide an improved autonomous vehicle system that utilizes vehicle status data, such as a health of one or more components of a vehicle, to plan a duty cycle for the autonomous vehicle. Specifically, component health, a load size or weight, and/or a start/stop cycle for one or more vehicles in a fleet may be used to determine a route for one or more autonomous vehicles of a fleet such that downtime of the one or more vehicles (e.g., time spent idle, in maintenance, etc.) is reduced. Furthermore, the systems, methods, and apparatuses described herein provide a technical solution to the technical problem of autonomous vehicle route planning by providing an improved, centralized maps to each of the vehicles in a fleet, in real-time or near real-time, such that each of the vehicles uses the most up-to-date map available for route planning to improve autonomous operation (e.g., avoid collisions with obstacles). Specifically, the improved, centralized map is generated based on real-time sensor data collected by one or more vehicles in a fleet. The real-time sensor data is compared to historical (e.g., previously generated) sensor data and map data, and an updated map is generated based on discrepancies between the real-time sensor data and the historical sensor data.

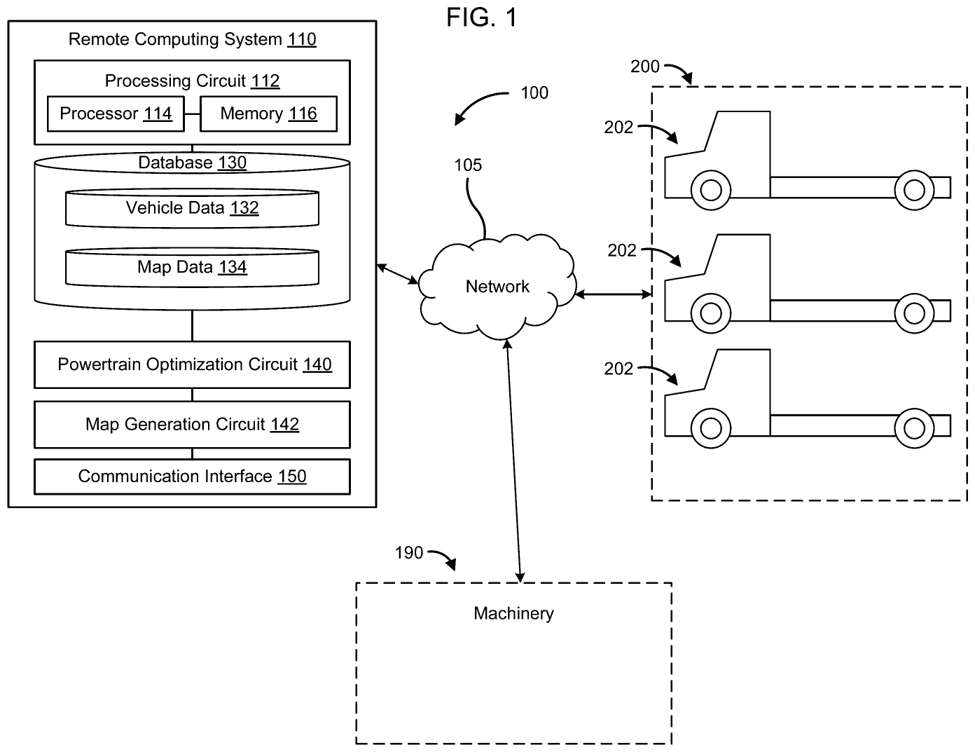

Referring now to FIG. 1, a block diagram of a system 100 for optimizing autonomous vehicle operation is shown, according to an example embodiment. As shown in FIG. 1, the system 100 includes a network 105, a remote computing system 110 and a fleet 200 having one or more vehicles 202. In some embodiments, the system 100 also includes machinery 190. Each of the components of the system 100 are in communication with each other and are coupled by the network 105. Specifically, the remote computing system 110, the computing and/or control systems of vehicles 202, and/or the machinery 190 are communicatively coupled to the network 105 such that the network 105 permits the direct or indirect exchange of data, values, instructions, messages, and the like (represented by the double-headed arrows in FIG. 1). In some arrangements, the network 105 is configured to communicatively couple to additional computing system(s). In operation, the network 105 facilitates communication of data between the remote computing system 110 and other computing systems associated with a service provider or with a customer or business partner of the service provider (e.g., a vehicle or vehicle fleet owner, a vehicle operator, a shipping port or warehouse owner, and the like) such as a user device (e.g., a mobile device, smartphone, desktop computer, laptop computer, tablet, or any other suitable computing system). The network 105 may include one or more of a cellular network, the Internet, Wi-Fi, Wi-Max, a proprietary provider network, a proprietary service provider network, and/or any other kind of wireless and/or wired network.

The remote computing system 110 is a remote computing system such as a remote server, a cloud computing system, and the like. Accordingly as used herein, “remote computing system” and “cloud computing system” are interchangeably used to refer to a computing or data processing system that has terminals distant from the central processing unit (e.g., processing circuit 112) from which users and/or other computing systems (e.g., the computing/control systems of the vehicle 202) communicate with the central processing unit. In some embodiments, the remote computing system 110 is part of a larger computing system such as a multi-purpose server, or other multi-purpose computing system. In other embodiments, the remote computing system 110 is implemented on a third party computing device operated by a third party service provider (e.g., AWS, Azure, GCP, and/or other third party computing services).

In some embodiments, the remote computing system is a port automation system, a warehouse automation system, or other system for controlling autonomous vehicles in a predefined area, such as a port area, warehouse area, and the like.

The remote computing system 110 is operated by a product and/or service provider associated with the system 100. Accordingly, in some embodiments, the remote computing system 110 is a service and/or system/component provider computing system and in turn controlled by, managed by, or otherwise associated with a service provider, a system/component provider (e.g., an engine manufacturer, a vehicle manufacturer, an exhaust aftertreatment system manufacturer, etc.), and/or a fleet operator. In the example shown, the remote computing system 110 is associated with a fleet operator that operates in a goods transportation and storage area, such as a shipping port or a warehouse. In other embodiments, the remote computing system 110 may additionally and/or alternatively be operated and managed by an engine manufacturer (which may also manufacture and commercialize other goods and services). Accordingly, an employee or other operator associated with the service and/or system/component provider and/or the fleet operator may operate the remote computing system 110.

As shown in FIG. 1, the remote computing system 110 includes a processing circuit 112, a database 130, one or more specialized processing circuits, shown as a powertrain optimization circuit 140 and a map generation circuit 142, and a communications interface 150. The processing circuit 112 is coupled to the specialized processing circuits, the database 130 and/or the communications interface 150. The processing circuit 112 includes a processor 114 and a memory 116. The memory 116 is one or more devices (e.g., RAM, ROM, Flash memory, hard disk storage) for storing data and/or computer code for completing and/or facilitating the various processes described herein. The memory 116 is or includes non-transient volatile memory, non-volatile memory, and non-transitory computer storage media. The memory 116 includes database components, object code components, script components, or any other type of information structure for supporting the various activities and information structures described herein. The memory 116 is communicatively coupled to the processor 114 and includes computer code or instructions for executing one or more processes described herein. The processor 114 is implemented as one or more application specific integrated circuits (ASICs), field programmable gate arrays (FPGAs), a group of processing components, or other suitable electronic processing components. As such, the remote computing system 110 is configured to run a variety of application programs and store associated data in a database and/or the memory 116.

The communications interface 150 is structured to receive communications from and provide communications to other computing devices, users, and the like associated with the remote computing system 110. The communications interface 150 is structured to exchange data, communications, instructions, and the like with an input/output device of the components of the system 100. In some arrangements, the communications interface 150 includes communication circuitry for facilitating the exchange of data, values, messages, etc. between the communications interface 150 and the components of the remote computing system 110. In some arrangements, the communications interface 150 includes machine-readable media for facilitating the exchange of information between the communications interface 150 and the components of the remote computing system 110. In some arrangements, the communications interface 150 includes any combination of hardware components, communication circuitry, and machine-readable media.

In some embodiments, the communications interface 150 includes a network interface. The network interface is used to establish connections with other computing devices by way of the network 105. The network interface includes program logic that facilitates connection of the remote computing system 110 to the network 105. In some arrangements, the network interface includes any combination of a wireless network transceiver (e.g., a cellular modem, a Bluetooth transceiver, a Wi-Fi transceiver) and/or a wired network transceiver (e.g., an Ethernet transceiver). For example, the communications interface 150 includes an Ethernet device such as an Ethernet card and machine-readable media such as an Ethernet driver configured to facilitate connections with the network 105. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted. Accordingly, the remote computing system 110 may be structured to facilitate encrypting and decrypting data sent to and from the remote computing system 110. For example, the remote computing system 110 may be structured to encrypt data transmitted by the communications interface 150 to other devices on the network 105, such as a user device.

In an example embodiment, the communications interface 150 is structured to receive information from one or more vehicles 202 (e.g., via the network 105), and provide the information to the components of the remote computing system 110. The communications interface 150 is also structured to transmit data from the components of the remote computing system 110 to the one or more vehicles 202.

The memory 116 may store a database 130, according to some arrangements (alternatively, the database 130 may be separate from the memory 116). The database 130 retrievably stores data associated with the remote computing system 110 and/or any other component of the system 100. That is, the data includes information associated with each of the components of the system 100. For example, the data includes information about the one or more vehicles 202. The information about the one or more vehicles 202 includes vehicle data 132. The vehicle data 132 includes information received from the one or more vehicles 202 and/or metadata including information about the one or more vehicles 202. For example, the vehicle data 132 includes location information such as a vehicle location and/or a vehicle distance traveled. The vehicle data 132 also includes vehicle operational data, such as powertrain information (e.g., engine fuel consumption rate, a total fuel consumption over a predetermined time period or distance, a battery state of charge, a battery consumption rate, a total battery charge consumption rate over a predetermined time or distance, a health of an exhaust aftertreatment system, etc.). The vehicle data 132 also includes powertrain performance information such as powertrain work time, powertrain idle time, powertrain exhaust data (e.g., exhaust gas/particle concentration), and/or other powertrain operational parameters. The metadata may also include an powertrain serial number, a vehicle identification number (VIN), a calibration identification and/or verification number, a make of the vehicle, a model of the vehicle, a unit number of a power unit of the vehicle, a unique identifier regarding a controller of the vehicle (e.g., a unique identification value (UID)), and/or a vehicle maintenance history (including a vehicle exhaust aftertreatment health history). Any of the data described above may include additional metadata such as a timestamp of when the data was gathered and/or when the data was transmitted or received by the remote computing system 110. The predetermined time periods described above may include a trip time, a work cycle (e.g., day, week, month, etc.), a time period between vehicle service, a predetermined vehicle lifespan, and the like. Accordingly, any of the information described above may include corresponding metadata.

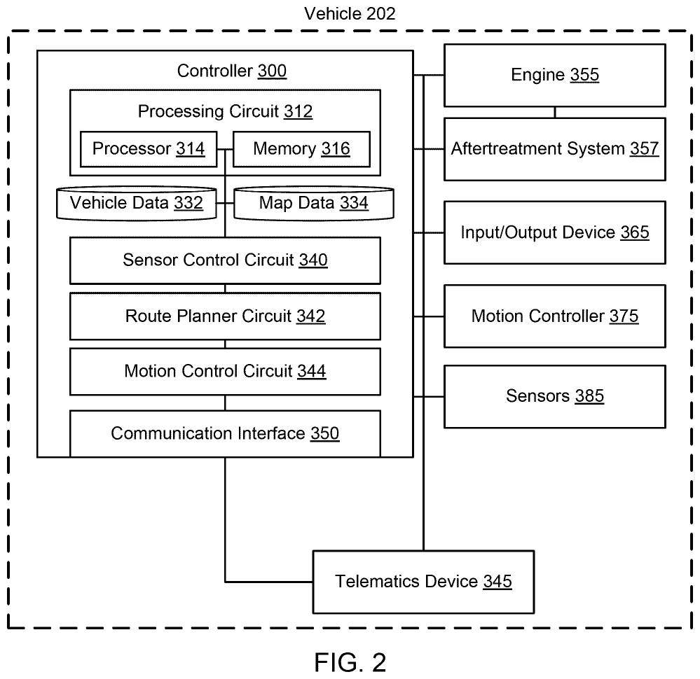

The database 130 also stores map data 134. The map data 134 may include information related to a predetermined location associated with remote computing system 110. The predetermined location may include a shipping port, a warehouse, and/or other predetermined area(s). The map data 134 may include route information, such as the location of roads, paths, etc. The map data 134 may also include the location of one or more components of the machinery 190, obstacles that may block a vehicle from moving along a road or path, and/or other information related to generating a map of the predetermined location. In some embodiments, the map data 134 may include sensor data detected by one or more sensors, such as the vehicle sensors 385 shown in FIG. 2, and/or other sensors associated with the predetermined location. The sensor data may include three-dimensional image data that depicts the location of the roads, paths, machinery components, obstacles, and/or other objects within the predetermined location. In some embodiments, the map data 134 may be used to generate a map of the predetermined area (e.g., by the map generation circuit 142). The map may be used to enable the vehicles 202 to autonomously navigate the predetermined area. In some embodiments, the map data 134 includes previously generated maps. In some embodiments, the map data 134 may be updated in real-time (e.g., every second, every millisecond, etc.) with new map data. The new map data may include sensor data received from the vehicle sensors 385 and/or maps generated by the map generation circuit 142. The new map data may include detections by one or more sensors, such as the sensors 385 of one or more vehicles and/or other sensors. For example, the new map data may include object detections such that the layout of the predefined area may change over time such that where one path previously existed that path may no longer exist due to the presence of an object in that pathway. In some embodiments, the map data 134 may be updated responsive to receiving additional sensor data and/or newly generated maps. In some embodiments, only a portion of the map data 134 is updated. For example, a portion of the map data 134 that is different than the new map data (e.g., a difference between a portion the new map data 134 and a corresponding portion of the new map data is greater than or equal to the predetermined threshold), may be updated. Other portions of the map data 134 that are not different than the new map data (e.g., a difference between a portion of the map data 134 and a corresponding portion of the new map data is less than the predetermined threshold) may not be updated.

In some embodiments, the map data 134 includes edge map data (e.g., map data 334) from the one or more vehicles 202. As briefly described above, the map data 134 may be updated in real-time. At least a portion of the map data 134 (e.g., the most recently updated map data 134), may be transmitted to the one or more vehicles 202, such that the vehicles 202 have the most updated version of the map data 134. In additional and/or alternative embodiments, the map data 134 includes sensor data from other sensors positioned within or near the predetermined location. In some embodiments, the other sensors are off-vehicle sensors or stationary sensors.

The database 130 also stores machinery information associated with the machinery 190. The machinery information includes information regarding the location, position, or type of machinery 190 within the predetermined area. For example, the machinery information may include types and locations of machinery. The machinery information may also include machinery metadata including a machinery registration, a machinery device ID, and/or other identifiers for identifying the machinery 190. In some embodiments, the machinery information may include a current position, orientation, or operational status of the machinery 190. In some embodiments, map generation circuit 142 may use any of the above-described machinery information to at least partially generate the map data 134. The data stored by the database 130 is retrievable, viewable, and/or editable by the remote computing system 110 (e.g., by a user input).

The database 130 may be configured to store one or more applications and/or executables to facilitate tracking data (e.g., vehicle data, fleet data, and/or user device data), managing real-time incoming data, generating or updating statistical models (e.g., machine learning models), or any other operation described herein. In some arrangements, the applications and/or executables are incorporated with an existing application in use by the remote computing system 110. In some arrangements, the applications and/or executables are separate software applications implemented on the remote computing system 110. The applications and/or executables may be downloaded by the remote computing system 110 prior to its usage, hard coded into the memory 116 of the processing circuit 112, or be a network-based or web-based interface application such that the remote computing system 110 provides a web browser to access the application, which may be executed remotely from the remote computing system 110 (e.g., by a user device). Accordingly, the remote computing system 110 includes software and/or hardware capable of implementing a network-based or web-based application. For example, in some instances, the applications and/or executables include software such as HTML, XML, WML, SGML, PHP (Hypertext Preprocessor), CGI, and like languages.

In the latter instance, a user (e.g., a provider employee, a customer, etc.) may log onto or access the web-based interface before usage of the applications and/or executables. In this regard, the applications and/or executables are supported by a separate computing system including one or more servers, processors, network interface, and so on, that transmit applications for use to the remote computing system 110.

In one embodiment, and as shown in FIG. 1, the remote computing system 110 includes a powertrain optimization circuit 140 that includes any combination of hardware and software for analyzing vehicle data such as the vehicle data 132 stored by the database 130. The powertrain optimization circuit 140 may be structured to analyze the vehicle data 132 (e.g., vehicle operational data, vehicle metadata, etc.). The powertrain optimization circuit 140 may also be structured to generate, based on analyzing the vehicle data 132 and/or predetermined parameters associated with one or more vehicles 202 of the fleet 200, a work schedule (e.g., a duty cycle, a desired load amount, a desired working duration, etc.) for the one or more vehicles 202. The work schedule may be generated responsive to and/or based on a transportation request. In an example embodiment, the transportation request may include a request to transport a load from a first location (e.g., an origin location) to a second location (e.g., a destination location). In further example embodiments, the transportation request may include a request to transport one or more loads to and from locations corresponding to each of the one or more loads. Thus, a work schedule may include multiple requests for transporting a load from a first location to a second location and/or a single request for transporting multiple loads to and from various locations.

As briefly described above, in some embodiments, the remote computing system 110 is structured to receive data from the one or more vehicles 202, and via the communications interface 150. The received data is stored in the database 130 (e.g., with the vehicle data 132). In some embodiments, the powertrain optimization circuit 140 may determine the work schedule based on the vehicle data 132. For example, the powertrain optimization circuit 140 may receive a request to transport a load from a first location (e.g., an origin location) to a second location (e.g., a destination location). In some embodiments, the powertrain optimization circuit 140 receives one or more requests. The powertrain optimization circuit 140 may select a vehicle 202 from the fleet 200 for each of the one or more requests. In some embodiments, the powertrain optimization circuit 140 may assign one vehicle 202 to multiple requests in series (e.g., completing one request after another) and/or in parallel (e.g., completing multiple requests concurrently or partially concurrently). For example, the vehicle 202 may transport multiple loads corresponding to different requests at the same time. The multiple loads may have the same destination or different destinations.

The powertrain optimization circuit 140 may select the vehicle 202 based on the vehicle data 132 and/or information included with the request. In some embodiments, the powertrain optimization circuit 140 may select the vehicle 202 based on a powertrain type. For example, the vehicle data 132 may include an indication of whether the vehicle 202 includes a diesel powertrain, an electric powertrain, a hybrid powertrain, or other powertrain.

In some embodiments, the powertrain optimization circuit 140 may select the vehicle 202 based on a load value of the request. For example, the request may include a load value (e.g., a size or weight of the load in kilograms, pounds, etc.). The vehicle data 132 may include an indication of a threshold load (e.g., a minimum load, a maximum load, a load range, an ideal load, etc.) that the vehicle 202 can transport. The powertrain optimization circuit 140 may compare the load value of the transport request to the load threshold of a vehicle (e.g., a first vehicle). The powertrain optimization circuit 140 may select a first vehicle of the fleet 200 responsive to determining that the load value satisfies the load threshold. More specifically, the powertrain optimization circuit 140 may select the first vehicle responsive to determining that the load value is at or below the maximum load threshold, at or above the minimum load threshold, within a load range, or within a predetermined amount of the ideal load (e.g., within 10%, within 20%, etc.).

In some embodiments, the powertrain optimization circuit 140 may select the vehicle 202 based on a route that the vehicle 202 will take between the first location and the second location. In some embodiments, the powertrain optimization circuit 140 may select the vehicle 202 based on environmental factors, such as a threshold emissions value for an individual vehicle 202 or the fleet 200. In some embodiments, the powertrain optimization circuit 140 may select the vehicle 202 based on a state of charge (SOC) of a battery electric or hybrid powertrain vehicle 202. In these embodiments, the powertrain optimization circuit 140 may also select the vehicle 202 based on optimizing energy usage and a battery system health.

In some embodiments, the powertrain optimization circuit 140 may select the vehicle 202 based on a fueling parameter of a vehicle 202. For example, the vehicle 202 may be a diesel fuel powered vehicle. In these embodiments, the powertrain optimization circuit 140 may select the vehicle 202 based on a diesel system health, including an exhaust aftertreatment system health (e.g., a diesel particulate filter (DPF) regeneration schedule), a diesel engine performance optimization, scheduled start/stop times for the diesel engine, and/or a controller reference schedule based on a vehicle duty cycle. For example, the powertrain optimization circuit 140 may select a vehicle 202 based on an indication that the DPF requires regeneration (or another catalyst/component may require regeneration based on various data, such as an elapsed time since a last regeneration that indicates a need for a regeneration). The powertrain optimization circuit 140 may assign the vehicle 202 to first request of the one or more request that includes a higher duty cycle (e.g., a larger/heaver load, a longer distance, etc.) such that the increased duty cycle causes the aftertreatment system to increase in temperature causing DPF regeneration. Specifically, the powertrain optimization circuit 140 may identify, based on the vehicle data 132, that a vehicle 202 is scheduled for or is in need of DPF regeneration (e.g., based on system health information and/or a schedule in the vehicle data 132). The powertrain optimization circuit 140 may assign the vehicle 202 to a heavy load duty cycle to increase the exhaust temperatures and burn off the soot on the DPF.

In some embodiments, the powertrain optimization circuit 140 may use the vehicle data 132 to determine whether an operational parameter of the vehicle 202 is exceeding a threshold parameter (e.g., above a maximum value, below a minimum value). The operational parameter may be an emission value (e.g., a nitrous-oxide value, a carbon dioxide value, a particulate matter value, etc.), a fuel level, a battery state of charge, a health of an exhaust aftertreatment system, an engine knock value, a fuel consumption value, a battery charge consumption value, and/or other parameters related to the operation of the vehicle 202. The threshold parameter may be a fueling threshold (e.g., a fuel consumption rate, a fuel storage amount, etc.), a battery threshold (e.g., a battery state of charge, a battery charge consumption rate, etc.), an emissions threshold (e.g., an emissions output value, an exhaust aftertreatment system health, etc.), and/or other thresholds related to operational parameters of the vehicle 202. In some embodiments, the powertrain optimization circuit 140 may determine the work schedule based on the powertrain optimization circuit 140 determining whether an operational parameter is exceeding a threshold parameter.

In additional and/or alternative embodiments, the powertrain optimization circuit 140 may compare the operational parameters of a first vehicle of the fleet 200 with other vehicles of the fleet 200. In some embodiments, the comparison may be made among powertrains of a similar type. In other embodiments, the comparison may be made among all the vehicles of the fleet 200, irrespective of the powertrain type. In some embodiments, the powertrain optimization circuit 140 may determine the work schedule based on the comparison.

In one embodiment, and as shown in FIG. 1, the remote computing system 110 includes a map generation circuit 142 that includes any combination of hardware and software for analyzing the map data 134 and generating a map based on the map data 134. The map generation circuit 142 is structured to analyze the map data 134 and, based the map data 134 (e.g., location data, sensor data, roads, paths, vehicle location, machinery location, etc.) and/or predetermined parameters associated with the predetermined area, generate a map of the predetermined area. For example, the remote computing system 110 is structured to receive sensor data from the vehicles 202 and/or sensor data from off-vehicle sensors via the communications interface 150. The received sensor data is stored in the database 130 (e.g., with the map data 134). The map generation circuit 142 generates, based on the map data 134, a map of the predetermined area. The “map” may provide an indication of pathways available, road grade associated with the pathways, other road characteristics (e.g., curvature, etc.), terrain features (e.g., asphalt road, gravel road, etc.), the presence of objects, and so on. The map generation circuit 142 may update the map in real-time based on receiving additional data from the vehicles 202 and/or the off-vehicle sensors. Accordingly, the map generation circuit 142 receives the map data 134, analyses the map data 134 and transforms the map data 134 into a useable map, such as a three-dimensional map, for enabling autonomous control of the vehicles 202. For example, the map generation circuit 142 may use a computer vision analysis to identify aspects of the map data 134 (e.g., distinguishing between a road, a wall, a pedestrian, a vehicle, an obstacle, etc.). The map generation circuit 142 may use the identified aspects to create a map (e.g., a three-dimensional map) for the vehicles 202.

As briefly described above, the map data 134 may include previously generated maps. Accordingly the map generation circuit 142 may use the previously generated maps to generate a new map. In some embodiments, the map generation circuit 142 may be structured to update a previously generated map with new sensor data received from one or more vehicles 202 and/or off-vehicle sensors. In some embodiments, the map generation circuit 142 may generate a new map and/or an updated map based on comparing new sensor data from the one or more vehicles 202 and/or off-vehicle sensors with previously received sensor data from the one or more vehicles 202 and/or off-vehicle sensors, and determining, based on the comparison, that one or more characteristics of the sensor data has changed. The one or more characteristics may include a real-time position of an obstacle, a real-time position of a vehicle 202, a real-time position of the machinery 190, etc. In some embodiments, the map generation circuit 142 may update the map data 134 with a new map and/or an updated map responsive to generating a new map. For example, the onboard vehicle sensors (e.g., sensors 385) may acquire sensor data while traveling along a route (e.g., location, grade, curvature, presence of objects, etc.) to generate a map based on traveled locations. The off-vehicle sensors may acquire sensor data of the predetermined area. For example, each of the off-vehicle sensors may be configured to acquire sensor data for at least a portion of the predetermined area (e.g., a location, a vehicle path, a pedestrian path, etc.). In some embodiments, the off-vehicle sensors are structured to continuously acquire sensor data, compare newly acquired sensor data with previously collected sensor data, and send the new sensor data to the remote computing system 110 based on determining that the new sensor data is different than the previously collected sensor data. As briefly described above, the map data 134 may include sensor data from a plurality of vehicles 202 and/or a plurality of off-vehicle sensors. The map generation circuit 142 may use the map data 134 that is specific to each of a plurality of vehicle sensors and/or each of a plurality of off-vehicle sensors to generate a new aggregate map and/or update an existing map.

The one or more vehicles 202 of the fleet 200 are vehicles having a power unit such as an engine (e.g., an internal combustion engine, a hybrid engine, an electric engine). The vehicles may also include a battery or other power storage device. In some embodiments and in the example depicted, the one or more vehicles 202 are terminal tractors configured to move semi-trailers within a predefined area, such as a shipping port, a warehouse, etc. The one or more vehicles 202 and/or the fleet 200 may be associated with a service provider, a vehicle type (e.g., engine type, chassis type, workload type, etc.), and/or any other parameter associated with the vehicle 202 or fleet 200.

The machinery 190 may include any machinery for moving and/or storing loads, such as containers, cranes, and other, non-vehicles. In some embodiments, the loads may include semi-trailers, cargo containers, etc. In some embodiments, the machinery 190 may be configured to move the loads between an off-vehicle location and one or more of the vehicles 202 and/or store the loads at an off-vehicle location. Accordingly the machinery 190 may include cranes, lifts, etc. for transporting the loads. The machinery 190 may be autonomous, user operated, or a combination thereof. Accordingly, the machinery 190 may include control circuitry including any combination of hardware and software for controlling the operation of the machinery 190. In some embodiments and as shown in FIG. 1, the machinery 190 may communicatively couple to the remote computing system 110 and/or the vehicles 202 via the network 105. In some embodiments, the machinery 190 is remotely controlled by the remote computing system 110.

FIG. 2 is a block diagram of a vehicle 202 of the system 100 of FIG. 1, according to an example embodiment. In some embodiments, the vehicle 202 may any type of passenger or commercial automobile, such as a commercial on-road vehicle including but not limited to, a line haul truck (e.g., a semi-truck, a school bus, a garbage truck, etc.); a non-commercial on-road vehicle, such as a car, truck, sport utility vehicle, cross-over vehicle, van, minivan, automobile; an off-road vehicle, such as tractor, airplane, boat, forklift, front end loader, etc.; and/or any other type of machine or vehicle that is suitable for the systems described herein. In the example depicted, the vehicle 202 is a terminal tractor, as described above.

The vehicle 202 is shown to include an engine 355. The engine 355 may be any type of internal combustion engine, such as a gasoline, natural gas, hydrogen fuel, and/or diesel engine, and/or any other suitable engine. In some embodiments, the engine 355 may be embodied in a hybrid engine system (e.g., a combination of the internal combustion engine and an electric motor). In other embodiments, the engine 355 is excluded and an only an electric engine is included with the vehicle (e.g., a full electric vehicle where power may come from a fuel cell, one or more batteries, etc.). For example, the vehicle 202 may include a fuel cell stack that includes individual membrane electrodes that use hydrogen and oxygen to produce electricity to power an electric engine, a fuel tank for storing hydrogen fuel, and one or more batteries for storing electrical power. The engine 355 may include one or more cylinders and associated pistons whereby the one or more cylinders may be arranged in a variety of ways (e.g., v-arrangement, inline, etc.). Air from the atmosphere is combined with fuel, and combusted, to produce power for the vehicle. Combustion of the fuel and air in the compression chambers of the engine 355 produces exhaust gas that is operatively vented to an exhaust pipe and to, in some embodiments, an exhaust aftertreatment system 357. While not shown, the vehicle 202 may also include additional systems, such as a lubrication system, a hydraulic system, and/or other systems.

The exhaust aftertreatment system 357 is coupled to the engine 355, and is structured to treat exhaust gases from the engine 355, which enter the aftertreatment system 357 via an exhaust pipe or conduit, in order to reduce the emissions of harmful or potentially harmful elements (e.g., NOx emissions, particulate matter, SOx, greenhouse gases, CO, etc.). The aftertreatment system 357 may include various components and systems, such as any combination of diesel oxidation catalysts (DOC), diesel particulate filters (DPF), and/or selective catalytic reduction (SCR) systems. The SCR system converts nitrogen oxides present in the exhaust gases produced by the engine 355 into diatomic nitrogen and water through oxidation within a catalyst. The DOC is configured to oxidize hydrocarbons and carbon monoxide in the exhaust gases flowing in the exhaust gas conduit system. The DPF is configured to remove particulate matter, such as soot, from exhaust gas flowing in the exhaust gas conduit system.

The vehicle 202 is also shown to include a controller 300. The controller 300 may be structured as one or more vehicle controllers/control systems, such as one or more electronic control units. The controller 300 may be separate from or included with at least one of a transmission control unit, an exhaust aftertreatment control unit, a powertrain control module, an engine control module or unit, or other vehicle controllers. In one embodiment, the components of the controller 300 are combined into a single unit. In another embodiment, one or more of the components may be geographically dispersed throughout the system or vehicle. In this regard, various components of the controller 300 may be dispersed in separate physical locations of the vehicle 202. All such variations are intended to fall within the scope of the disclosure.

The vehicle 202 includes a sensor array that includes a plurality of sensors, shown as sensors 385. The sensors are coupled to the controller 300, such that the controller 300 can monitor, receive, and/or acquire data indicative of operation of the vehicle 202 (which may be referred to as operational data associated with the vehicle, operational parameters, and similar terms herein). In this regard, the sensors 385 may include one or more physical (real) or virtual sensors.

In some embodiments, the sensors 385 may include temperature sensors. The temperature sensors acquire data indicative of or, if virtual, determine an approximate temperature of various components or systems at or approximately at the disposed location(s) of the sensors 385.

In some embodiments, the sensors 385 may include an emissions sensor that acquire data indicative of or, if virtual, determine an approximate amount or concentration of emissions in the exhaust gas stream at or approximately at their disposed locations (e.g., immediately downstream of the engine 355, immediately downstream of the aftertreatment system, etc.). In some embodiments, the sensors 385 may include an exhaust aftertreatment sensor that acquires data indicative of or, if virtual, determines a health of an exhaust aftertreatment system 357 of the vehicle 202. The health of the exhaust aftertreatment system may include a temperature of one or more components of the exhaust aftertreatment system (e.g., a catalyst), an indication of whether a diesel particulate filter (DPF) requires a regeneration, and/or other parameters associated with the health of the exhaust aftertreatment system. The sensors 385 may also include pressure sensors for sensing (or determining in the case of a virtual sensor) a pressure value at an upstream side and a downstream side of one or more of the components of the aftertreatment system. The upstream pressure value and the downstream pressure value may be used to determine a change of pressure across the aftertreatment system component. In some embodiments, the DPF may require a regeneration based on a predetermined schedule (e.g., a predetermined time period, a predetermined distance traveled, a predetermined duty cycle, etc.). The sensors 385 may also include a speed sensor that is configured to provide a speed signal to the controller 300 indicative of a vehicle speed. In some embodiments, there may be a sensor that provides a speed of the vehicle (e.g., miles-per-hour) while in other embodiments the speed of the vehicle may be determined by other sensed or determined operating parameters of the vehicle (e.g., engine speed in revolutions-per-minute may be correlated to vehicle speed using one or more formulas, a look-up table(s), etc.).

The sensors 385 may include a fuel tank level sensor that determines a level of fuel in the vehicle 202, such that a fuel economy may be determined based on the speed of the vehicle relative to the fuel consumed by the engine 355 (i.e., to determine a distance-per-unit of fuel consumed, such as miles-per-gallon or kilometers-per-liter, etc.). Additional examples of sensors 385 may be used alone or in combination to determine a fuel economy for the vehicle 202 include, but are not limited to, an oxygen sensor, an engine speed sensor, a mass air flow (MAF) sensor, and a manifold absolute pressure sensor (MAP). Based on the foregoing, the controller 300 may determine a fuel economy for the vehicle 202 which may be provided to the operator via the I/O device 365. In electric and/or hybrid vehicles, the sensors 385 may include a battery sensor that determines a state-of-charge of one or more batteries of the vehicle 202, such that the controller 300 may determine a distance-per-unit of battery charge consumed.

The sensors 385 may include a flow rate sensor that is structured to acquire data or information indicative of flow rate of a gas or liquid through the vehicle 202 (e.g., exhaust gas through an aftertreatment system or fuel flow rate through an engine, exhaust gas recirculation flow at a particular location, a charge flow rate at a particular location, an oil flow rate at various positions, a hydraulic flow rate at a particular location, etc.). The flow rate sensor(s) may be coupled to the engine 355, an aftertreatment system of the vehicle 202, and/or elsewhere in the vehicle 202.

The sensors 385 may further include any other sensors. Such sensors may be used to determine a duty cycle for the vehicle 202, and particularly, the engine 355. A duty cycle refers to a repeatable set of data, values, or information indicative of how the specific vehicle is being utilized for a particular application. In particular, a “duty cycle” refers to a repeatable set of vehicle operations for a particular event or for a predefined time period. For example, a “duty cycle” may refer to values indicative of a vehicle speed for a given time period. In another example, a “duty cycle” may refer to values indicative of an aerodynamic load on the vehicle for a given time period. In yet another example, a “duty cycle” may refer to values indicative of a vehicle speed and an elevation of a vehicle for a given time period. In this regard and compared to a vehicle drive cycle, which is typically limited to time versus speed information, the term “duty cycle” as used herein is meant to be broadly interpreted and inclusive of vehicle drive cycles among other quantifiable metrics. Beneficially and based on the foregoing, the “duty cycle” may be representative of how a vehicle may operate in a particular setting, circumstance, or environment (e.g., within portions of the predetermined area). In this regard, the vehicle duty cycle may vary greatly based on the vehicle powertrain type (e.g., a diesel vehicle, a diesel electric vehicle, a hybrid vehicle, an electric vehicle, etc.). Duty cycle parameters may include therefore, but are not limited to, average engine load for a predefined time period (which may be determined by a MAP sensor or other sensors), a fuel consumption rate per time (e.g., gallons-per-hour as determined by a fuel consumption sensor), a fuel economy per unit of time, a charge consumption rate per time, a charge consumption rate per distance, a value indicative of an amount time that the vehicle is in an idle (i.e., not moving such as when the vehicle is in a park transmission setting), etc. Based on the foregoing, the controller 300 may track a total operation time based on total engine hours (total time engine is/was on) which may then be demarcated by vehicle drive time (time engine was on and vehicle was moving as evidenced by a vehicle speed above a threshold amount, such as zero miles-per-hour), idle time (time engine is on but the vehicle is not moving), and other demarcation possibilities.

In some embodiments, the sensors 385 may include a map sensor that acquires data indicative of or, if virtual, determines map data (e.g., the map data 334). Accordingly, the sensors 385 may include a positioning sensor (e.g., a GPS sensor, a GNSS sensor, a RTK sensor, etc.), a computer vision sensor (e.g., a camera, a radar sensor, a LIDAR sensor, etc.), and/or other suitable sensor for detecting the position of the vehicle 202 and/or a position of one or more objects proximate the vehicle 202, such as a shipping container, the machinery 190, etc.

In some embodiments, the sensors 385 may include a load sensors that acquires data indicative of or, if virtual, determines a load carried by the vehicle 202 (e.g., in kilograms, pounds, etc.). In these embodiments, any of the above sensor data may further include an indication of the load carried by the vehicle 202.

It should be understood that other different/additional sensors may also be included with the vehicle 202, such as an accelerator pedal position (APP) sensor, a pressure sensor, an engine torque sensor, a battery sensor, etc. Those of ordinary skill in the art will appreciate and recognize the high configurability of the sensors and their associated positions in the vehicle 202. The controller 300 is structured to provide the operational data to a communicatively coupled device (e.g., the remote computing system 110) via the communications interface 350 or, in some embodiments, via the telematics unit 345.

The vehicle 202 may also include an operator input/output (I/O) device 365. The operator I/O device 365 may be coupled to the controller 300, such that information may be exchanged between the controller 300 and the I/O device 365, where the information may relate to one or more components of the vehicle 202 and/or one or more determinations of the controller 300. The operator I/O device 365 enables an operator of the vehicle 202 to communicate with the controller 300 and one or more components of the vehicle 202 of FIG. 1. For example, the operator input/output device 365 may include, but is not limited to, an interactive display, a touchscreen device, one or more buttons and switches, voice command receivers, etc. In this way, the operator input/output device 365 may provide one or more indications or notifications to an operator, such as a malfunction indicator lamp (MIL), etc.

In one embodiment, the vehicle 202 includes a telematics unit 345. In some embodiments, the telematics unit 345 may communicatively couple to the remote computing system 110. In some embodiments, one or more of the sensors 385 may be embodied in the telematics unit 345. For example, the telematics unit or device 345 may include, but is not limited to, a location positioning system (e.g., GPS, GNSS, etc.) to track the location of the vehicle (e.g., latitude and longitude data, elevation data, etc.), one or more memory devices for storing the tracked data, and one or more electronic processing units for processing the tracked data. In some embodiments, the telematics unit 345 is coupled to a communications interface 350 for facilitating the exchange of data between the telematics unit and one or more remote devices (e.g., a provider/manufacturer of the telematics unit 345, etc.). For example, the communications interface 350 may be structured to communicatively couple the telematics unit 345 with the remote computing system 110. In this regard, the communications interface 350 may be configured as any type of mobile communications interface or protocol including, but not limited to, Wi-Fi, WiMAX, Internet, Radio, Bluetooth, ZigBee, satellite, radio, Cellular, GSM, GPRS, LTE, and the like. The telematics unit 345 may also be communicatively coupled to the controller 300 of the vehicle 202. The communication interface 350 may also be communicatively coupled to the controller 300. In other embodiments, the telematics unit 345 may be excluded and the controller 300 may couple directly to the remote computing system 110 (e.g., via wired and/or wireless connections) and exchange information directly with those systems without the intermediary of the telematics unit 345.

The communication interface 350 may include any type and number of wired and wireless protocols (e.g., any standard under IEEE 802, etc.). For example, a wired connection may include a serial cable, a fiber optic cable, an SAE J1939 bus, a CAT5 cable, or any other form of wired connection. In comparison, a wireless connection may include the Internet, Wi-Fi, Bluetooth, ZigBee, cellular, radio, etc. In one embodiment, a controller area network (CAN) bus including any number of wired and wireless connections provides the exchange of signals, information, and/or data between the controller 300, the telematics unit 345, and/or the communication interface 350. In still another embodiment, the communication between the components of the vehicle 202 (e.g., the controller 300, telematics unit 345, and the communication interface 350) is via the unified diagnostic services (UDS) protocol.

As alluded above, the controller 300 may be structured to include the entirety of the communication interface 350 or include only a portion of the communications interface 350. In these latter embodiments, the communication interface 350 is communicatively coupled to the processing circuit 312. In other embodiments, the controller 300 is substantially separate from the communication interface 350. For example, the controller 300 and the communication interface 350 are separate control systems, but may be communicatively and/or operatively coupled. The communications interface 350 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and, in some embodiments (e.g., when the telematics unit 345 is excluded) out-of-vehicle communications (e.g., directly with the remote computing system 110). In this regard, in some embodiments, the communications interface 350 may include a network interface. The network interface is used to establish connections with other computing devices by way of the network 105. The network interface includes program logic that facilitates connection of the controller 300 to the network 105. The network interface includes any combination of a wireless network transceiver (e.g., a cellular modem, a Bluetooth transceiver, a Wi-Fi transceiver) and/or a wired network transceiver (e.g., an Ethernet transceiver). Thus, in some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted. For example and regarding out-of-vehicle/system communications, the communications interface 350 may include an Ethernet card and port for sending and receiving data via an Ethernet-based communications network and/or a Wi-Fi transceiver for communicating via a wireless communications network. The communications interface 350 may be structured to communicate via local area networks and/or wide area networks (e.g., the Internet) and may use a variety of communications protocols (e.g., IP, LON, Bluetooth, ZigBee, radio, cellular, near field communication, etc.). Furthermore, the communications interface 350 may work together or in tandem with the telematics unit 345 in order to communicate with other vehicles in the fleet 200 of one or more vehicles 202.

In the example shown, the controller 300 includes a processing circuit 312 having a processor 314 and a memory device 316. The processing circuit 312 may be configured to execute or implant the instructions, commands, and/or control processes described herein. The controller 300 may also include one or more specialized processing circuits shown as a sensor control circuit 340, a route planner circuit 342, and a motion control circuit 344.

The processor 314 may be implemented as one or more processors, one or more application specific integrated circuits (ASIC), one or more field programmable gate arrays (FPGAs), a digital signal processor (DSP), a group of processing components, or other suitable electronic processing components. The one or more processors may be shared by multiple circuits. Alternatively or additionally, the one or more processors may be configured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. The memory device 316 (e.g., RAM, ROM, Flash Memory, hard disk storage, etc.) may store data and/or computer code for facilitating the various processes described herein. The memory device 316 may be communicably coupled to the processor 314 to provide computer code or instructions to the processor 314 for executing at least some of the processes described herein. Moreover, the memory device 316 may be or include tangible, non-transient volatile memory or non-volatile memory. Accordingly, the memory device 316 may include database components, object code components, script components, or any other type of information structure for supporting the various activities and information structures described herein.

The memory 316 may store data associated with the vehicle 202 shown as vehicle data 332. The vehicle data 332 is similar to the vehicle data 132 except in that the vehicle data 332 includes data for a particular vehicle 202. The memory 316 may also store map data 334. The map data 334 includes map information detected by the sensors 385. In some embodiments, the controller 300 is configured to receive map data 134 from the remote computing system 110 such that the map data 334 also includes the map data 134.

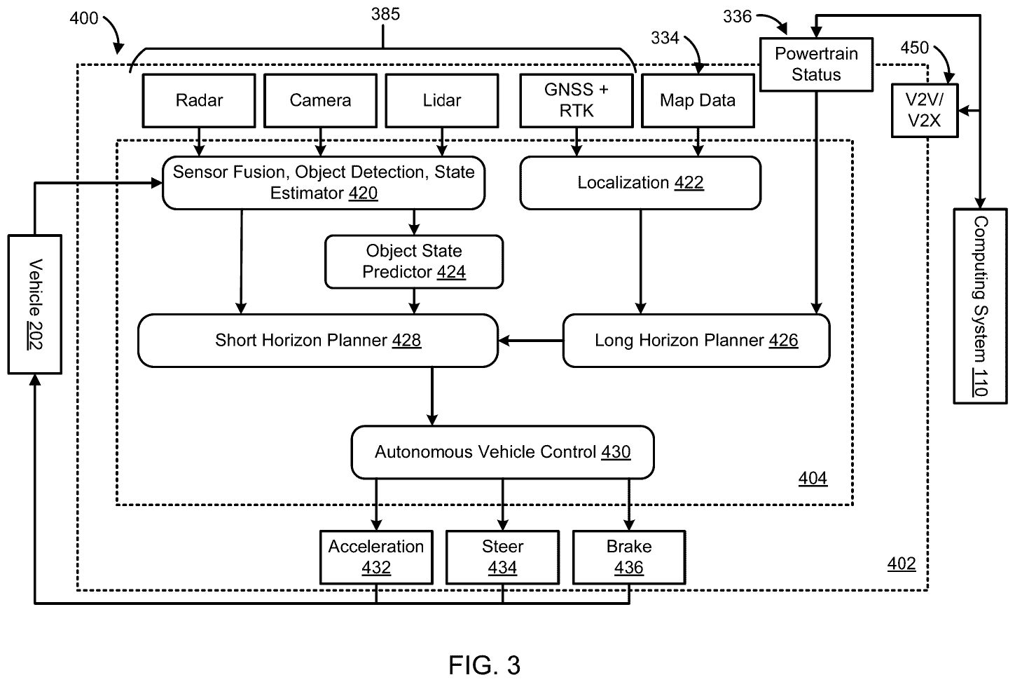

The memory 316 may be configured to store one or more applications and/or executables to facilitate tracking data (e.g., vehicle data 332, map data 334, etc.), managing real-time incoming data, generating or updating statistical models (e.g., machine learning models), or any other operation described herein. In some arrangements, the applications and/or executables are embodied in the one or more specialized processing circuits (e.g., the sensor control circuit 340, a route planner circuit 342, and a motion control circuit 344). In some arrangements, the applications and/or executables are incorporated with an existing application in use by the controller 300. In some arrangements, the applications and/or executables are separate software applications implemented on the controller 300. The applications and/or executables may be downloaded by the controller 300 prior to its usage, hard coded into the memory 316 of the processing circuit 312, or be a network-based or web-based interface application such that the controller 300 uses a web browser to access the application, which may be executed remotely from the remote computing system 110 (e.g., by a user device). Accordingly, the controller 300 includes software and/or hardware capable of implementing a network-based or web-based application. For example, in some instances, the applications and/or executables include software such as HTML, XML, WML, SGML, PHP (Hypertext Preprocessor), CGI, and like languages. In some embodiments, the one or more applications and/or executables may include an application for enabling autonomous control of the vehicle 202, described herein with respect to FIG. 3.

Now referring to the specialized processing circuits, in some embodiments, the controller 300 is configured as an on-board computing device (e.g., onboard the vehicle 202) that captures data including vehicle operational parameters. The sensor control circuit 340 may be configured to enable the controller 300 to control the operation of the sensors 385. As one example, the controller 300 is communicatively coupled to the sensors 385 such that the sensor control circuit 340 may cause the sensors 385 to detect the vehicle operational parameters described herein and/or detect the map data 334 described herein. In another example, the controller 300 receives operational parameters directly via one or more sensors onboard the vehicle. In yet another example, the controller 300 receives operational parameters and determines operational parameters from information from the telematics unit 345, information from real sensors onboard the vehicle, and determined from information from sensors onboard the vehicle. The controller may store the data (e.g., in the memory device 316). The controller 300 may provide the data to the remote computing system via the communication interface 350.

The route planner circuit 342 is configured to determine a route for the vehicle to travel between a first location (e.g., a starting location) and a second location (e.g., a destination location). The route planner circuit 342 may use the map data 334 and/or the vehicle data 332 to determine the route. In some embodiments, the route may be determined based on the map data 334. For example, the route may be determined based on a distance traveled, traffic of other vehicles 202, locations of machinery 190, and/or other obstacles or objects. In some embodiments, the route may be determined based on the vehicle data 332. For example, the route may be determined based on a fueling or charging parameter of the vehicle 202, a health of a vehicle aftertreatment system, and/or other vehicle parameters. In some embodiments, the route planner circuit 342 may be configured to determine a route having more than two destinations.

The motion control circuit 344 is configured to control the motion of the vehicle 202, such that the motion control circuit 344 enables autonomous control/operation of the vehicle 202. The motion control circuit 344 enables the vehicle 202 to be at least partially automated. That is, the vehicle 202 may include varying levels of automation ranging from partially automated (e.g., cruise control being enabled) to fully enabled (e.g., vehicle completely drives itself). For example, motion control circuit 344 may enable the vehicle 202 at a level 5 of automation, which enables full automated driving. Level 0 provides for no driving automation, Level 1 provides for some driver assistance, Level 2 provides for partial driving automation, Level 3 provides for conditional driving automation, Level 4 provides for high driving automation, and Level 5 (the highest level) provides for full driving automation. Depending on the level of automation, the self-driving vehicle 202 may control the transmission (e.g., shift gears) automatically without input from a human driver. In an example embodiment, the systems, methods, and apparatuses described herein are applicable with vehicles (such as the vehicles 202), or, more specifically, terminal tractors having Level 2 automation or higher. In some embodiments, the motion control circuit 344 may control a steering, acceleration, and braking of the vehicle 202. That is, the controller 300 and/or one or more components thereof (e.g., the motion control circuit 344) may generate controller commands for controlling the motion of the vehicle. More specifically, the controller 300 may generate an acceleration command to activate an accelerator of the vehicle 202 and cause the engine to increase fueling in order to accelerate, a steering command to change a steering direction of the vehicle 202 (e.g., move a steering device to move the wheels of the vehicle 202), a brake command to activate a brake of the vehicle 202 (e.g., friction brakes, etc.), a gear shift command to change a transmission setting of the vehicle, etc. The commands generated by the controller 300 cause the vehicle to move at a particular speed and direction and/or enable a change in speed and/or direction.

In some embodiments, the functionality of the controller 300 may be split between the controller 300, the telematics unit 345, and/or other components of the vehicle 202. All such variations are intended to fall within the scope of the disclosure.

Referring now to FIG. 3, a flow diagram of a method 400 of autonomous vehicle control by the system of FIG. 1 is shown, according to an example embodiment. In some embodiments, one or more of the computing systems of the system 100 is configured to perform method 400. For example, the remote computing system 110 and/or the controller 300, may be structured to perform, at least parts thereof, the method 400. In the depicted example embodiment, the controller 300 performs the method 400, alone or in combination with other devices such as the remote computing system 110 and/or other devices of the vehicle 202. The method 400 may include user inputs from a user (e.g., a vehicle operator, etc.) via one or more user devices (such as a user device, a user device integrated with a vehicle, etc.). The method 400 may include inputs from other computing devices, such as computing devices of the machinery 190. In some arrangements, the processes of the method 400 may be performed in a different order than as shown in FIG. 3 and/or the method 400 may include more or fewer steps than as shown in FIG. 3.

In some embodiments and as shown in FIG. 3, the method 400 may include inputs and/or outputs from the remote computing system 110 and the vehicle 202. In some embodiments, the inputs and/or outputs may be received by a vehicle system 402. The vehicle system 402 may be onboard the vehicle 202 and include any of the components of the vehicle 202, as shown in FIG. 2, such as the controller 300, one or more sensors 385, and any combination of software and hardware for enabling autonomous control of the vehicle 202. As shown in FIG. 3, the vehicle system 402 may include an autonomous driving software 404 for enabling autonomous control of the vehicle 202. In the embodiment shown, the software 404 is embodied in the controller 300 (e.g., stored by the memory 316). In additional and/or alternative embodiments, the software may be stored by the remote computing system 110 and remotely accessed by the controller 300.

Referring to the method 400 in more detail, the method 400 may include receiving, by the vehicle system 402 may communicatively couple with various components/systems (e.g., other vehicles, remote computing system 110, etc.) via a vehicle-to-vehicle and/or vehicle-to-everything (V2V and/or V2X) system 450. The communications interface 350 may provide V2V and/or V2X system 450 (e.g., via Bluetooth communications, Wi-Fi communications, etc.). In some embodiments, the vehicle system 402 may provide vehicle data 332 to the remote computing system 110. As shown in FIG. 3, the vehicle system 402 may provide a powertrain status 336 to the remote computing system 110. In some embodiments, the vehicle system 402 may receive a work schedule from the remote computing system 110.

As described above, the remote computing system 110 may determine the work schedule for the vehicle 202. The remote computing system 110 may provide the work schedule to the vehicle system 402 associated with the vehicle 202. As described above, the remote computing system 110 may receive one or more requests to transport a load within the predetermined area. In some embodiments, the one or more requests may additionally and/or alternatively include load scheduling information. The remote computing system 110 also receives the vehicle data 332 which may include the powertrain status 336. The powertrain status 336 may include an indication of a powertrain type and an indication of availability of a vehicle 202, such as an indication of available duty cycle. That is, the remote computing system 110 may communicate with the available vehicles to obtain vehicle state information including a powertrain type, system health status, etc. The remote computing system 110 may determine, based on a container type and characteristics, such as load, size, etc., to select a vehicle 202 of the fleet 200 for a request of the one or more requests. The remote computing system 110 may pass information of the request (e.g., load, size, first location, second location, etc.) to the vehicle system 402. The first location (e.g., a starting location) and/or the second location (e.g., a destination location) may refer to a container location, a docking station, a fueling station, a container storage location, a location of the machinery 190 (e.g., stackers/crane locations), a service station location, or other location in the predetermined area.

As briefly described above, the remote computing system 110 and/or a component there of, such as the powertrain optimization circuit 140, may generate a work schedule for a vehicle 202 selected for a request of the one or more requests. The vehicle 202 may be selected and the work schedule generated based on one or more factors such as a load size (e.g., weight, size, etc.), vehicle availability, vehicle capabilities (e.g., maximum or minimum load), emissions thresholds (e.g., emission limits, emission targets, etc.), current vehicle location, predicted or future vehicle location, and/or other parameters. In some embodiments, the remote computing system 110 may select a vehicle and/or generate a work schedule based on other factors including, but not limited to a DPF regeneration schedule, providing a map update, a re-fueling optimization, or a vehicle powertrain optimization. It should be understood that the remote computing system 110 may select a vehicle and/or generate a work schedule based on any of the factors described herein individually or in any combination.

In some embodiments, the remote computing system 110 may identify the systems in need of a regeneration (e.g., DPF, SCR, etc.) based on received vehicle data 332. For example, the remote computing system 110 may receive vehicle data 332 that includes system health information and a schedule for a vehicle 202 for heavy load duty cycle to increase the exhaust temperatures and burn off the soot on the system/component that is in need of regeneration (e.g., DPF).

In some embodiments, the remote computing system 110 may receive map data (e.g. the map data 334) from each of the vehicles 202 of the fleet 200 (e.g., from on-board sensors 385 of the vehicles 202). In some embodiments, the remote computing system 110 may receive map data from one or more off-vehicle sensors.

In any of the above-described embodiments, the remote computing system 110 may compare the received map data with the map data 134. The remote computing system 110 may determine, based on comparing the map data with the map data 134 whether the map data contains new or different information than the map data 134. In some embodiments, the remote computing system 110 may identifies a position, an orientation, and/or operational state of one or more objects in each of the map data and the map data 134. The position may be an absolute positon that is numerically defined (e.g., by latitude and/or longitude) or a relative positon within the predetermined area that is defined by a set of local coordinates (e.g., Cartesian coordinates or polar coordinates relative to an origin point of the predetermined area). The orientation may include a directional facing (e.g., north, south, etc.) or a specific angular facing (e.g., a compass orientation 30°, 180°, 210°, etc. and/or a three-dimensional angular set of values). The operational state may include an object's velocity (e.g., speed and direction) and/or acceleration (e.g., change in speed and direction of the change in speed).

The remote computing system 110 may compare the position, orientation, and/or operational state of each of the one or more objects in the map data with the position, orientation, and/or operational state of one or more objects in the map data 134. More specifically, the remote computing system 110 may determine a difference between the position, orientation, and/or operational state of each of the one or more objects in the map data and the position, orientation, and/or operational state of one or more objects in the map data 134. For example, the remote computing system 110 may determine a difference between the position of the one or more objects in the map data and the corresponding objects in the map data 134 (e.g., by determining a distance between longitudinal and latitudinal coordinates and/or a distance between Cartesian coordinates or polar coordinates within the predetermined area). In another example, the remote computing system 110 may determine a difference between the orientations by determining a difference between an angular facing of the one or more objects in the map data and the corresponding objects in the map data 134 (e.g., a change in angle). In yet another example, the remote computing system 110 may determine a difference in the operational state by determining a difference between the velocity and/or acceleration of the one or more objects in the map data and the corresponding objects in the map data 134. In any of the above-described embodiments, the difference may be an absolute difference or a percent difference or other value.

In some embodiments, the remote computing system 110 may determine that the map data contains new information responsive to determining that an object in the map data is not present in the map data 134 and/or responsive to determining that an object in the map data 134 is not present in the map data.

In some embodiments, the remote computing system 110 may update the map data 134 responsive to determining that the map data contains new or different information. For example, the map data may indicate that an object is blocking path, that a piece of machinery 190 is blocking a path, that a new road sign has been placed on a path, and/or other update information regarding the predetermined area.

In some embodiments, the remote computing system 110 may update the map data 134 responsive to determining that a difference between the map data and the map data 134 is equal to or greater than a predetermined threshold. In some embodiments, the predetermined threshold is a percent difference between map data and the map data 134 (e.g., 5%, 10%, etc.). In other embodiments, the predetermined threshold is a predetermined value such as a predetermined distance, a predetermined angle, a predetermined velocity, a predetermined acceleration, etc.

In some embodiment, the remote computing system 110 may discard the map data response to determining that the map data does not contain new or different information and/or that the difference between the map data and the map data 134 is less than the predetermined threshold.

In some embodiments, the remote computing system 110 may provide a map of the predetermined area to the vehicles. In some embodiments, the map includes map data 134. In some embodiments, the map is a three-dimensional map. in some embodiments, the remote computing system 110 may provide an updated map to the vehicles 202 of the fleet 200. In some embodiments, the remote computing system 110 may provide the updated map to a vehicle 202 responsive to assigning the vehicle 202 to a request. In some embodiments, the remote computing system 110 may provide the updated map to a vehicle 202 responsive to updating the map.

In some embodiments, the remote computing system 110 may track fuel levels and/or battery SOC of each vehicles 202 and optimize assigning the vehicles 202 to the one or more requests the based on fuel economy, a status of fuel in vehicle, a battery SOC, a battery charge depletion rate, etc. For example, the remote computing system 110 may select a job for a vehicle 202 such that it can avoid an extra trip for refueling or recharging when refueling or recharging is not needed based on received information regarding the vehicle. The remote computing system 110 may schedule refueling or recharging during slow periods when the fewer requests are being received and/or the demand for the vehicles 202 is minimum, thus increasing the uptime of vehicles 202 in the fleet 200. In some embodiments, if refueling or recharging is needed during the peak time, remote computing system 110 may schedule vehicles with low fuel or low SOC such that the low fuel/low SOC vehicles may complete a maximum number of jobs while following a refueling/recharging route. The refueling/recharging route may include one or more refueling/recharging stations along the refueling/recharging route such that a vehicle 202 may refuel or recharge without deviating from a predetermined route or duty cycle.

In some embodiments, the remote computing system 110 may select a vehicle 202 based on an appropriate powertrain for the request (e.g., based on a route, load, vehicle state, etc.) such that maximum fuel efficiency and minimum downtime is achieved. For example, the remote computing system 110 may schedule electric vehicles for low load and or shorter routes and diesel or fuel cell vehicles for heavy load and longer routes.

Still referring to FIG. 3, the vehicle system 402 communicates with the remote computing system 110 to provide vehicle data 332, which may include powertrain status 336 to the remote computing system 110. The remote computing system 110 provides a work schedule to the vehicle system 402 via the V2X 450 (or, in some embodiments, via another vehicle—i.e., indirectly—via V2V) and causes the vehicle system 402 to update the powertrain status 336 with the work schedule. The work schedule may include information about the request to transport a load including location information (e.g., the first location and the second location), load information (e.g., load size, etc.), refueling/recharging instructions (e.g., a refueling/recharging route), and/or other information about the load.

Referring now to the software 404, at process 420, the controller 300 receives sensor data from the sensors 385. In some embodiments, the received sensor data is real-time sensor data that is received in real-time (e.g., every second, every millisecond, etc.). As shown in FIG. 3, the sensors 385 may include a radar, a camera, and LIDAR. In other embodiments, the sensors 385 may include any combination of hardware and software for enabling computer vision such that the vehicle is operable to collect map data 334. In some embodiments, the controller 300 is configured to combine the data received from one or more sensors 385 (shown as “sensor fusion” in FIG. 3). The controller 300 may use the combined data to identify or detect one or more objects (shown as “object detection” in FIG. 3). The one or more objects may be positioned within a predetermined distance of the vehicle 202. The controller 300 may estimate, based on the combine sensor data and responsive to detecting the one or more objects a state of the one or more objects (shown as “state estimator” in FIG. 3). The state of the one or more objects may include an indication of whether the one or more objects is moving, an indication of an orientation of the one or more objects relative to the vehicle 202, and/or other indications regarding the one or more objects.

At process 422, the controller 300 receives map data 334. In some embodiments, the map data 334 may be updated with the map data 134 from the remote computing system 110. The controller 300 may use the map data 334 in combination with sensor data from one or more sensors 385 (e.g., a GPS sensor, a GNSS sensor, a RTK sensor, etc.) to determine a localization including a present location of the vehicle 202.

At process 424, the controller 300 may analyze sensor data received at process 420. The analysis may include performing an object recognition on the sensor data to determine one or more characteristics of an object detected by the sensors 385. For example, the characteristics may include a position of the object, an indication of an object type, an indication of whether the object is moving, an indication if the object is a road sign (e.g., a stop sign, a stop light, a yield sign, etc.), etc. In some embodiments, the analysis may also include event detection including determining whether an object is moving and predicting a location to where the object is moving.

At process 426, the controller 300 uses a long horizon planner module to determine a route for the vehicle 202. In some embodiments, long horizon planner module is configured to determine an overall route including streets, roads, alleys, isles, or other pathways that the vehicle 202 can use within the predetermined area. The long horizon planner module may determine locations where the vehicle 202 should turn or continue straight to follow the route. In some embodiments, the long horizon planner module 426 is structured to determine a route to get from a present location (e.g., the localization determined at process 422) to the first location and from the first location to the second location. For example, the long horizon planner module 426 may determine a route for the vehicle 202 based on the location of the vehicle, the first location, and the second location. In some embodiments, determining the route may include determining, by the long horizon planner module 426, a plurality of possible routes and selecting, a first route. More specifically, the long horizon planner module 426 may select the first route based on at least one of (i) that a distance of the first route is less than a predefined distance threshold, (ii) a number of turns of the first route between the first location and the second location is less than a predefined turning threshold, (iii) a load of the first route experienced between the first location and the second location is at or below a predefined maximum load threshold, or (iv) a load of the first route experience between the first location and the second location is at or above a predefined minimum load threshold.

In some embodiments, the best possible route may be defined by an attendant of the remote computing system 110, of the controller 300, etc. In some embodiments, the present location and the first location may be the same location. In some embodiments, the route is at least partially determined by an input from the remote computing system 110. For example and as shown in FIG. 3, the remote computing system 110 may provide at least part of the route as a refueling/recharging route. In some embodiments, the long horizon planner module uses the map data 134 and/or the map data 334 to determine the best possible route.

At process 428, the controller 300 uses a short horizon planner module to determine short term corrections to the route determined at process 426. The short term corrections refer to relatively shorter time and/or distance horizons than the determined overall route that corresponds with a relatively longer distance and/or time of operation horizon. The short term corrections/adjustment may include deviating from the route determined at process 426, for example by changing a speed (e.g., by accelerating or applying a brake), keeping a constant speed, changing direction, and/or keeping a constant direction. Accordingly the short term corrections cause the vehicle to deviate from the route (e.g., to avoid an obstacle). More specifically the short term corrections may cause the vehicle 202 to change speed or change direction to avoid one or more objects within the predetermined distance of the vehicle 202. The short term corrections may cause the vehicle 202 change speed or change direction based on the one or more characteristics of the object (e.g. stopping of the object is a stop sign, changing speed if the object is a speed limit sign, etc.). The short term corrections may cause the vehicle to change speed or change direction avoid a moving object based on determining a trajectory of the moving object and avoiding the trajectory of the moving object.

Advantageously, the controller 300 may use the sensor fusion, object detection, and/or state estimator determined at process 420 alone or in combination with the object state predictor 424. For example, the object detection and state estimator at process 420 may be faster than the object state predictor at process 424. More specifically, the detection of an object and estimation of a movement or position relative to the vehicle 202 may take less time than analyzing sensor data and determining a predicted state. Accordingly, the controller 300 may use the object detection and state estimator determined at process 420 to quickly make short term corrections. Furthermore, the controller 300 may use both the object detection and state estimator determined at process 420 in combination with the object state predictor 424 to make more precise short term corrections.

In some embodiments, the deviation may be temporary, and the short horizon planner module may determine a path to return to the route determined at process 426. In other embodiments, the deviation may require the long horizon planner module to determine a new route. In some embodiments, the short horizon planner module may determine a best possible path to follow the route determined at process 426 and avoid objects detected by the sensors at process 420 and identified at process 424. For example, the controller 300 may use the object and event detection preformed at process 424, to plan a deviated trajectory based on objects detected along the route. In some embodiments, the controller 300 may repeat processes 420, 424, and 428 continuously such that the vehicle 202 may continuously update a planned trajectory based on new sensor data.

At process 430, the controller 300 may use the determination made at process 428 to generate autonomous vehicle control signals. For example, the controller 300 may generate one or more autonomous vehicle control signals that cause the vehicle 202 to autonomously transport from a first location to a second location. More specifically, the one or more autonomous vehicle control signals may include an acceleration signal for an acceleration control 432. In some embodiments, the autonomous vehicle control signals are generated based on vehicle constraints such as threshold values for acceleration, steering, and braking. The acceleration control 432 may cause the vehicle 202 to accelerate by increasing a fueling rate of the engine, increasing a power provided to an electric motor, etc. The one or more autonomous vehicle control signals may include a steer control 434. The steer control 434 may cause the vehicle 202 to change direction by causing a vehicle steering assembly (e.g., steering wheel, steering gear, steering linkages, differential, wheels, tires, etc.) to actuate thereby causing the vehicle to change direction. The one or more autonomous vehicle control signals may include a brake control 436. The brake control 436 may cause the vehicle 202 to brake by causing a brake system of the vehicle 202 to actuate causing the wheels to slow or stop.

In addition to the features described above, the vehicle system 402 and/or the software 404 thereof may be configured to enable the vehicle for additional autonomous actions including automated start/stop management, stationary DPF regeneration, live map updating, and/or V2X autonomous job completion. In some embodiments, the vehicle system 402 may use start/stop techniques when the vehicle is not in use and is not being scheduled by remote computing system 110 for a request. Stopping a vehicle engine, powering down one or more systems or subsystems of the vehicle, and/or stopping other vehicle functions may save the fuel or battery charge and thereby reduce idle emissions. In some embodiments, the vehicle system 402 may identify that the vehicle 202 has high soot levels in the DPF using vehicle data 332 including system health information. The vehicle system 402 may automatically cause the vehicle to perform a stationary DPF regeneration to maintain the heath of the DPF system. The vehicle system 402 may communicate with the remote computing system 110 to indicate that the vehicle 202 is not available during the station DPF regeneration. In some embodiments, the vehicle system 402 may receive a map data 134 including at least a portion of the predetermined area along the route determined by the vehicle system 402 and/or the remote computing system 110. The vehicle system 402 may provide updated map data to the remote computing system 110 including an indication of any discrepancies between the updated map data and the map data 134. The remote computing system 110 may update the map data 134 to include the updated map data and may provide the map data 134, including the updated map data, to the vehicles 202 in the fleet 200.

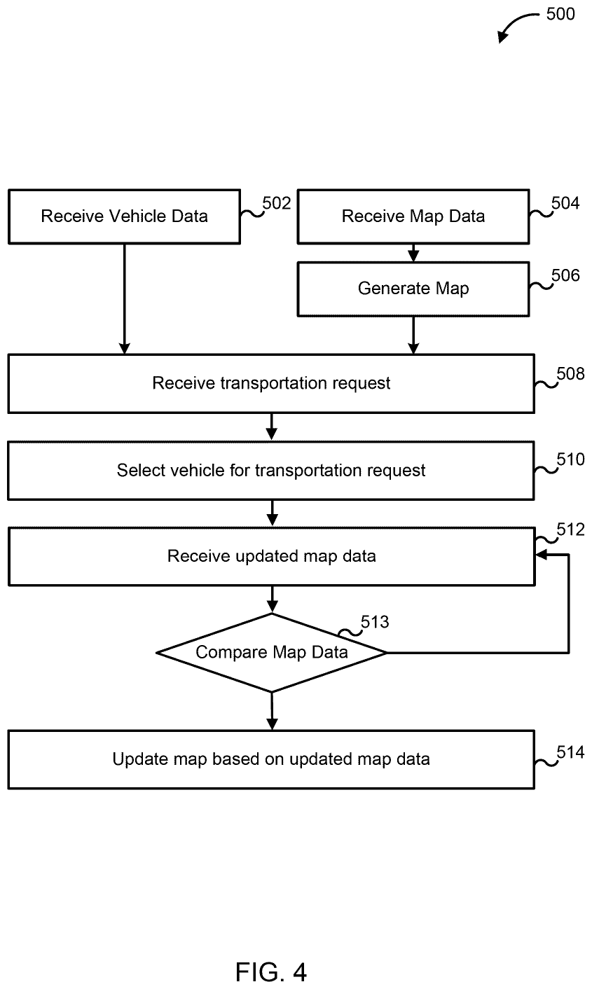

Referring now to FIG. 4, a flow diagram of a method 500 of autonomous vehicle control is shown, according to an example embodiment. In some embodiments, one or more of the computing systems of the system 100 is configured to perform method 500. For example, the remote computing system 110 and/or the controller 300, may be structured to perform, at least parts thereof, the method 500. In the depicted example embodiment, the remote computing system 110 performs the method 500, alone or in combination with other devices such as the controller 300. The method 500 may include user inputs from a user (e.g., a vehicle operator, etc.) via one or more user devices (such as a user device, a user device integrated with a vehicle, etc.).

As an overview of method 500, at process 502, the remote computing system 110 receives vehicle data. At process 504, the remote computing system 110 receives map data 334. At process 506, the remote computing system 110 generates a map. At process 508, the remote computing system 110 receives a transportation request. At process 510, the remote computing system 110 selects a vehicle for the transportation request. At process 512, the remote computing system 110 receives updated map data. At process 513, the remote computing system 110 compares the map data. At process 514, the remote computing system 110 updates the map based on the updated map data. In some arrangements, the processes of the method 500 may be performed in a different order than as shown in FIG. 4 and/or the method 500 may include more or fewer steps than as shown in FIG. 4.

Referring to the method 500 in more detail, at process 502, the remote computing system 110 receives vehicle data 342 from one or more vehicles 202. The remote computing system 110 may store the vehicle data from the one or more vehicles 202 in the vehicle data 132. At process 504, the remote computing system 110 receives map data 334 from one or more vehicles 202. In some embodiments, the remote computing system 110 additionally and/or alternatively receives map data from one or more off-vehicle sensors. The remote computing system 110 may store the map data 334 from the one or more vehicles 202 (or the map data from the one or more off-vehicle sensors) with the map data 144. At process 506, the remote computing system 110 generates a map based on the map data 144. As described above, the map generation circuit 142 may generate the map based on the map data 334 and/or the map data from the one or more off-vehicle sensors.

At process 508, the remote computing system 110 receives a transportation request. The transportation request may define a request to transport a load, such as a shipping container, from a first location to a second location. At process 510, the remote computing system 110 selects a vehicle for the transportation request, as described above. In some embodiments, the remote computing system 110 causes the selected vehicle 202 to autonomously move from the first location to the second location. For example, the remote computing system 110 may cause the vehicle 202 to use the autonomous driving software 404 of FIG. 2.

At process 512, the remote computing system 110 receives updated map data from the vehicle 202. The updated map data may include map data 334 that is detected as the vehicle 202 moves between the first location and the second location. In some embodiments, the remote computing system 110 causes the vehicle 202 to collect sensor data while autonomously transporting from the first location to the second location. At process 513, the remote computing system 110 compares the received map data 334 with the map data 134. Responsive to determining that a difference between the map data 334 and the map data 134 is equal to or greater than a predetermined threshold, the method 500 continues to process 514. Responsive to determining that a difference between the map data 334 (e.g., sensor data from the vehicle 202) and the map data 134 is less than a predetermined threshold, the method 500 returns to process 512. In some embodiments, responsive to determining that the difference between the map data 334 (e.g., sensor data from the vehicle 202) and the map data 134 is less than a predetermined threshold, thereby reducing the amount of memory used to store the map data 134. At process 514, the remote computing system 110 updates the map data 134 responsive to determining that the difference between the map data 334 and the map data 134 is equal to or greater than the predetermined threshold.

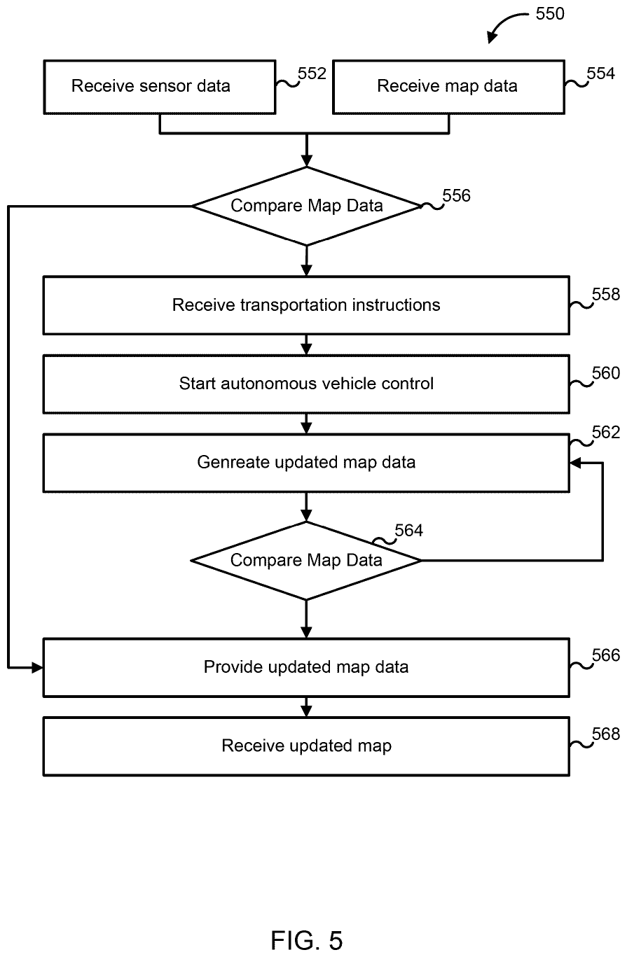

Referring now to FIG. 5, a flow diagram of a method 550 of autonomous vehicle control is shown, according to an example embodiment. In some embodiments, one or more of the computing systems of the system 100 is configured to perform method 550. For example, the remote computing system 110 and/or the controller 300, may be structured to perform, at least parts thereof, the method 550. In the depicted example embodiment, the controller 300 performs the method 550, alone or in combination with other devices such as the remote computing system 110. The method 550 may include user inputs from a user (e.g., a vehicle operator, etc.) via one or more user devices (such as a user device, a user device integrated with a vehicle, etc.).

As an overview of method 550, at process 552, the controller 300 receives sensor data. At process 554, the controller 300 receives map data 134. At process 556, the controller 300 compares the map data. At process 558, the controller 300 receives transportation instructions. At process 560, the controller 300 starts autonomous vehicle control. At process 562, the controller 300 generates updated map data. At process 564, the controller 300 compares the map data. At process 566, the controller 300 provides the updated map data. At process 568 the controller 300 receives an updated map. In some arrangements, the processes of the method 550 may be performed in a different order than as shown in FIG. 5 and/or the method 550 may include more or fewer steps than as shown in FIG. 5. For example, process 558 and process 560 may be preformed before and/or after process 552, process 554, and/or process 556.

Referring to the method 500 in more detail, at process 552, the controller 300 receives sensor data (e.g., from the sensors 385). The sensor data may include vehicle data 332 and/or map data 334. For example, the controller 300 may use the sensors 385 to detect the map data 334. At process 554, the controller 300 receives map data 134 from the remote computing system 110. At process 556, the controller 300 compares the map data 134 with the map data 334. Responsive to determining that a difference between the map data 334 and the map data 134 is less than a predetermined threshold, the process continues to process 558. Responsive to determining that a difference between the map data 334 and the map data 134 is equal to or greater than a predetermined threshold, the process continues to process 566.

At process 558, the controller 300 receives transportation instructions, as described above with respect to FIG. 3. At process 560, the controller 300 starts autonomous vehicle control, as described above with respect to FIG. 3.

At process 562, the controller 300 generates updated map data. For example, the controller 300 may use the sensors 385 to generate updated map data while the vehicle is in route from the first location to the second location.

At process 564, the controller 300 compares the updated map data with the map data 134. If there are no discrepancies between the map data 134 and the updated map data, the process continues to process 562. If there are discrepancies between the map data 134 and the map data 334, the process continues to process 566. At process 566, the controller 300 provides the updated map data to the remote computing system 110. At process 568 the controller 300 receives an updated map data from the remote computing system 110.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used hereinto describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1 and 2, it should be understood that the remote computing system 110 and/or the controller 300 may include any number of circuits for completing the functions described herein. For example, the activities performed by the powertrain optimization circuit 140 may be distributed into multiple circuits or combined as a single circuit. Additional circuits with additional functionality may also be included. Further, the controller 300 may further control other activity beyond the scope of the present disclosure.

As mentioned above and in one configuration, the “circuits” may be implemented in machine-readable medium storing instructions (e.g., embodied as executable code) for execution by various types of processors, such as the processor 114 of FIG. 1. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A remote computing system comprising:
a communication interface structured to couple to a network;
a map database storing centralized map data;
one or more processors; and
one or more memory devices storing instructions that, when executed by the one or more processors, cause the one or more processors to perform operations comprising:
receiving a transport request, the transport request comprising a first location and a second location;
selecting a first vehicle of a plurality of vehicles for the transport request, the first vehicle selected based on at least one of the transport request and a vehicle status for each of the plurality of vehicles;
selectively transmitting the centralized map data to the first vehicle;
causing the first vehicle to complete the transport request, wherein completing the transport request comprises:
causing the first vehicle to autonomously transport from the first location to the second location;
causing the first vehicle to collect first sensor data while autonomously transporting from the first location to the second location;
receiving the first sensor data; and
selectively updating the centralized map data with the first sensor data.

2. The remote computing system of claim 1, wherein the first vehicle is positioned at a third location, and wherein the operations further comprise:
causing the first vehicle to autonomously transport from the third location to the first location; and
causing the first vehicle to collect second sensor data while autonomously transporting from the third location to the first location.

3. The remote computing system of claim 1, wherein the operations further comprise:
comparing a load value of the transport request to a load threshold of the first vehicle; and
selecting the first vehicle responsive to determining that the load value is at or below the load threshold.

4. The remote computing system of claim 1, wherein the first sensor data comprises map data and the operations further comprise:
comparing the map data to the centralized map data;
responsive to determining that a difference between the map data and the centralized map data is less than a predetermined threshold, discarding the map data; and
responsive to determining that the difference between the map data and the centralized map data is equal to or greater than the predetermined threshold, updating the centralized map data.

5. The remote computing system of claim 4, wherein updating the centralized map data further comprises updating a first portion of the centralized map data, and wherein a difference between a portion the centralized map data and a corresponding portion of the map data is greater than or equal to the predetermined threshold.

6. The remote computing system of claim 1, wherein selectively transmitting the centralized map data to the first vehicle comprises providing a first portion of the centralized map data to the first vehicle, wherein the first portion of the centralized map data comprises information regarding a route between the first location and the second location.

7. The remote computing system of claim 1, wherein the operations further comprise:
communicably coupling to one or more sensors;
receiving, from the one or more sensors, map data;
comparing the map data to the centralized map data;
responsive to determining that a difference between the map data and the centralized map data is less than a predetermined threshold, discarding the map data; and
responsive to determining that the difference between the map data and the centralized map data is equal to or greater than the predetermined threshold, updating the centralized map data.

8. A method comprising:
receiving, by a computing system, a transport request, the transport request comprising a first location and a second location;
selecting, by the computing system, a first vehicle of a plurality of vehicles for the transport request, the first vehicle selected based on at least one of the transport request and a vehicle status for each of the plurality of vehicles;
selectively transmitting, by the computing system, centralized map data to the first vehicle;
causing, by the computing system, the first vehicle to complete the transport request, wherein completing the transport request comprises:
causing the first vehicle to autonomously transport from the first location to the second location, and
causing the first vehicle to collect first sensor data while autonomously transporting from the first location to the second location;
receiving, by the computing system, the first sensor data; and
selectively updating, by the computing system, the centralized map data with the first sensor data.

9. The method of claim 8, further comprising:
causing, by the computing system, the first vehicle to autonomously transport from a third location to the first location;
causing, by the computing system, the first vehicle to collect second sensor data while autonomously transporting from the third location to the first location.

10. The method of claim 8, further comprising:
comparing, by the computing system, a load value of the transport request to a load threshold of the first vehicle; and
selecting, by the computing system, the first vehicle responsive to determining that the load value is at or below the load threshold.

11. The method of claim 8, wherein the first sensor data comprises map data; and
wherein the method further comprises:
comparing, by the computing system, the map data to the centralized map data;
responsive to determining that a difference between the map data and the centralized map data is less than a predetermined threshold, discarding, by the computing system, the map data; and
responsive to determining that the difference between the map data and the centralized map data is equal to or greater than the predetermined threshold, updating, by the computing system, the centralized map data.

12. The method of claim 11, wherein updating the centralized map data further comprises updating, by the computing system, a first portion of the centralized map data, and wherein a difference between a portion the centralized map data and a corresponding portion of the map data is greater than or equal to the predetermined threshold.

13. The method of claim 8, wherein selectively transmitting the centralized map data to the first vehicle comprises providing, by the computing system, a first portion of the centralized map data to the first vehicle, wherein the first portion of the centralized map data comprises information regarding a route between the first location and the second location.

14. The method of claim 8, further comprising:
communicably coupling, by the computing system, to one or more sensors;
receiving, by the computing system and from the one or more sensors, map data;
comparing, by the computing system, the map data to the centralized map data;
responsive to determining that a difference between the map data and the centralized map data is less than a predetermined threshold, discarding, by the computing system, the map data; and
responsive to determining that the difference between the map data and the centralized map data is equal to or greater than the predetermined threshold, updating, by the computing system, the centralized map data.

15. The method of claim 8, further comprising:
receiving, by the computing system and from the first vehicle, vehicle data;
determining, by the computing system and based on the vehicle data, that the first vehicle is scheduled for or is in need of a particulate filter regeneration.

16. The method of claim 15, wherein selecting the first vehicle of the plurality of vehicles for the transport request comprises:
determining that the transport request is a high load request; and
selecting the first vehicle responsive to determining that the transport request is the high load request and determining that the first vehicle is scheduled for or is in need of the particulate filter regeneration.

17. A system comprising:
one or more sensors; and
a controller coupled to the one or more sensors, the controller configured to:
receive, from a remote computing system, map data;
receive, from the remote computing system, transportation instructions, the transportation instructions comprising a first location and a second location;
generate autonomous vehicle control signals, the autonomous vehicle control signals causing a vehicle including the system to autonomously transport from the first location to the second location;
receive, from the one or more sensors, sensor data while autonomously transporting from the first location to the second location; and
selectively updating the received map data with the sensor data.

18. The system of claim 17, wherein generating the autonomous vehicle control signals comprises:
determining a location of the vehicle based on the map data; and
determining a route for the vehicle based on the location of the vehicle, the first location, and the second location, wherein the route is selected based on at least one of:
a distance of the route is less than a predefined distance threshold,
a number of turns of the route between the first location and the second location is less than a predefined turning threshold,
a load of the first route experienced between the first location and the second location is at or below a predefined maximum load threshold, or
a load of the first route experience between the first location and the second location is at or above a predefined minimum load threshold.

19. The system of claim 18, wherein generating the autonomous vehicle control signals further comprises:
analyzing the sensor data by:
identifying one or more objects within a predetermined distance of the vehicle,
performing an object recognition on the sensor data to determine one or more characteristics of the one or more objects, and
determining whether each of the one or more objects is moving and a trajectory of each of the one or more objects,
responsive to analyzing the sensor data, determining at least one correction to the route, the at least one correction causing the vehicle to:
change a speed of the vehicle or change a direction of the vehicle to avoid the one or more objects within the predetermined distance of the vehicle,
change the speed of the vehicle or change the direction of the vehicle based on the one or more characteristics of the one or more objects, or
change the speed of the vehicle or change the direction of the vehicle to avoid the trajectory of each of the one or more objects.

20. The system of claim 17, wherein the autonomous vehicle control signals comprise at least one of:
an acceleration control that causes the vehicle to accelerate by increasing a fueling rate of an engine or increasing a power provided to an electric motor;
a steer control that causes the vehicle to change direction by actuating a vehicle steering assembly; or
a brake control that causes the vehicle to brake by actuating a brake system of the vehicle.
